(19) United States
(12) Patent Application Publication
(10) Pub. No.: US 2019/0055085 A1
(43) Pub. Date: Feb. 21, 2019

(54) LID LOCKING APPARATUS AND METHOD FOR TRASH CONTAINER

(71) Applicant: HODGE PRODUCTS, INC., Santee, CA (US)

(72) Inventors: Anthony A. Hodge, Santee, CA (US); Bruce F. Gonzalez, JR., Santee, CA (US)

(21) Appl. No.: 15/678,949

(22) Filed: Aug. 16, 2017

(51) Int. Cl. B65F 1/16; E05B 67/38

(52) U.S. Cl. CPC B65F 1/1615; E05B 63/0052; E05B 67/383

(57) ABSTRACT

A trash container locking apparatus comprises first and second pivot arms with first ends pivoted to mounting plates secured to opposite sides of a trash container and a bar extending between second ends of the arms. The pivot arms can be pivoted upwards and rearwards between an unlocked condition in which the bar extends across the front of the container and a locked position in which the bar extends across the closed lid of the container. The first arm has an outwardly projecting locking flange with at least one opening, and the mounting plate for that arm has an outwardly projecting stop plate which has an opening aligned with the opening in the locking flange in the locked position. A padlock shackle is extended through the aligned openings to lock the flange to the mounting plate to prevent opening of the container lid without a key or padlock combination.

### BACKGROUND

### Related Field

The subject matter discussed herein relates generally to locking apparatus and methods for locking the hinged or removable lids of commercial or large size trash containers or bins by means of a pivoted, lockable bar extending over the lid in the closed position.

### Related Background

Many trash container locking systems are known in which a bar is attached to pivot arms on opposite sides of a trash container for movement between an unlocked position across the front of the container in which the lid can be freely opened and closed, and a locked position extending over the top of the closed lid so it cannot be opened. A locking mechanism is provided to lock one of the arms in place when the bar extends across the top of the lid. Such systems are described, for example, in U.S. Pat. No. 5,029,724 of Serio, U.S. Pat. No. 5,213,382 of Dawdy, and U.S. Pat. Nos. 6,733,053 and 8,313,126 of Hodge Products, Inc. A lid locking system sold by HPI (Hodge Products, Inc.) comprises two pivot arms pivotally mounted on base plates for securing to opposite sides of the trash container, and a separate lock plate to be mounted on one side of the container so that an opening in the pivot arm on that side is aligned with a hole in the lock plate or hasp in the locked position of the bar. Installation and proper alignment of the parts of this system may be difficult in some cases.

### SUMMARY

According to one aspect, a lid locking apparatus for a trash container comprises first and second pivot devices each having a mounting plate configured to be secured to a respective side edge of the trash container close to the front of the container and respective first and second pivot arms each having a first end pivotally mounted to the respective first and mounting plate and a second end adapted for connection to a respective end of an elongate pipe or bar which is longer than the front end of the trash container. The first pivot device is lockable and the first pivot arm has opposite side edges and an outwardly projecting locking flange on one side edge which has at least one slot or opening. The mounting plate of the first pivot device has a stop plate or padlock hasp extending outwardly from a side edge of the base plate in the same direction as the locking flange. The stop plate also has at least one slot or opening. When the mounting plates are secured by welding or the like to opposite sides of a trash container and a bar is secured between second ends of the pivot arms, the arms are rotatable between an unlocked position in which the bar extends across the front of the container and the hinged container lid can be freely opened and closed, and a locked position in which the bar and arms are pivoted upward and rearward so that the bar extends over the top of the container lid. The stop plate on the mounting plate and locking flange on the first pivot arm are positioned and oriented such that the locking flange is adjacent to the stop plate in the locking position with at least part of the opening in the locking flange aligned with an opening in the stop plate. A padlock shackle is engaged through the aligned openings to secure the bar in the locked position, preventing unauthorized dumping of trash in the container.

In one embodiment, the openings in the locking flange and stop plate each comprise an elongated slot for ease in alignment, but in alternative embodiments one of these parts may have a single circular opening or more than one circular opening while the other has an elongated slot. In one embodiment, the locking flange is positioned such that it is in face-to-face engagement with the stop plate in the locking position. In some embodiments, an indent is provided on one edge of the stop plate to act as a welding or attachment point for the chain of a padlock, so that the padlock can be permanently attached to the lockable pivot device and ready for engagement with the aligned openings or slots in the locking flange and stop plate to lock these parts together and prevent access to the container.

According to another aspect, a method of locking a trash container lid in a closed position comprises mounting first and second pivot mounting plates on opposite side rims of a trash container adjacent the front wall and upper end opening of the container; securing a locking bar between second ends of first and second pivot arms which have respective first ends pivotally mounted on the respective first and second pivot mounting plates; positioning the pivot arms in a first, unlocked position in which the locking bar extends across the front wall of the container; closing the lid of the container; rotating the first and second pivot arms in a first, locking direction upwards and rearwards until the locking bar extends across the closed lid of the container and a locking flange on the first pivot arm engages a stop plate on the first mounting plate which projects outwards from the first mounting plate and respective side rim of the container to prevent further movement of the pivot arms in the first, locking direction; and engaging the shackle of a padlock through aligned openings in the stop plate and locking flange and locking the shackle to the padlock body to retain the first and second pivot arms and locking bar in the locked position.

Other features and advantages of the present invention will become more readily apparent to those of ordinary skill in the art after reviewing the following detailed description and accompanying drawings.

### BRIEF DESCRIPTION OF THE DRAWINGS

FIG. 1 is a perspective view of the separated parts of a prior art trash container lid locking apparatus;

FIG. 2 is a side elevation view of the prior art apparatus of FIG. 1, illustrating one of the arms and the padlock hasp secured to one side of a trash container, in the lid locking position;

FIG. 3 is a perspective view illustrating the separated parts or pivot devices of one embodiment of a lid locking apparatus for a trash container;

FIG. 4 is a top perspective view of the locking pivot device of FIG. 3 with an attachment chain secured to a typical padlock and secured to a stop plate of the locking pivot device;

FIG. 5 is a rear elevation view of a modified stop plate;

FIG. 6 is a top view of the locking pivot device of FIGS. 3 and 4 with a locking flange on the pivot arm rotated at an angle relative to the pivot mount or base of the device;

FIG. 7 is a top plan view of part of the locking pivot device of FIGS. 1 3, 4, and 6 with the pivot arm rotated in an anti-clockwise direction from the position shown in FIG. 6 and a locking flange on the pivot arm engaged in face-to-face engagement with a stop plate on the pivot mount and locked to the stop plate with the padlock of FIG. 4;

FIG. 8 is side view of the locking pivot device in the position of FIG. 7 prior to attachment of a padlock;

FIG. 9 is a perspective, broken away view of the top portion of a trash container with the arms of the lid locking apparatus pivotally secured on opposite sides of the container and a bar secured between the free ends of the arms, in the unlocked position; and

FIG. 10 is a view similar to FIG. 9 but illustrating the bar pivoted upwards and rearwards over the top of the container lid and the lockable pivot arm in the locking position with the locking flange engaging the stop plate and secured by a padlock shackle extending through the aligned slots in the locking flange and stop plate, as in FIG. 7.

### DETAILED DESCRIPTION

The subject matter described herein is taught by way of example implementations. Various details have been omitted for the sake of clarity and to avoid obscuring the subject matter. The examples shown below are directed to devices, apparatus and methods for locking the lid of a large or commercial trash container in the closed position. Other features and advantages of the subject matter should be apparent from the following description.

After reading this description it will become apparent to one skilled in the art how to implement the invention in various alternative embodiments and alternative applications. However, all the various embodiments of the present invention will not be described herein. It is understood that the embodiments presented here are presented by way of an example only, and not limitation.

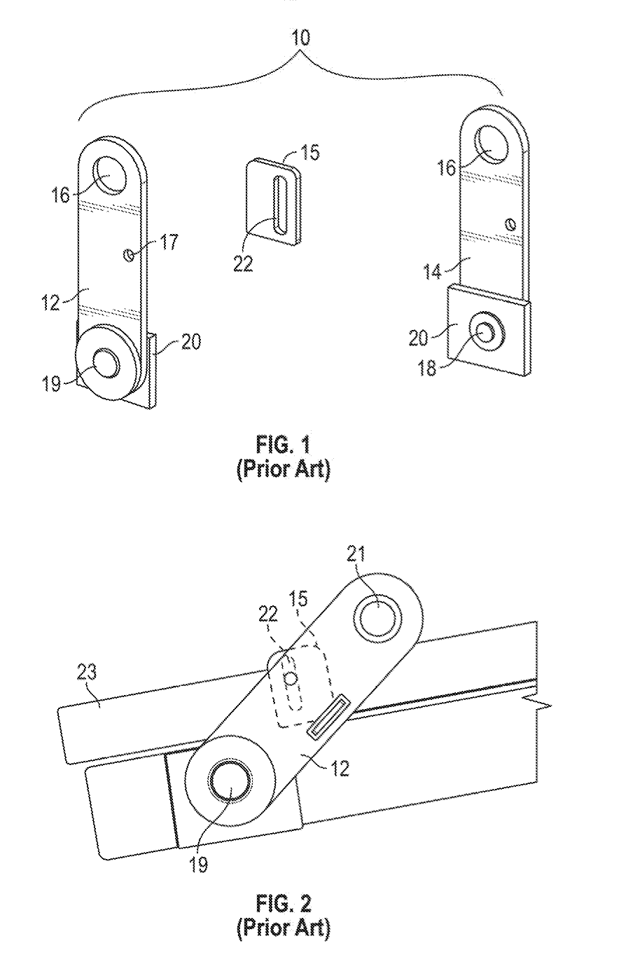

FIGS. 1 and 2 illustrate a prior art container lid locking apparatus or kit 10 which is sold by Hodge Products, Inc. (HPI). Apparatus 10 basically comprises left and right pivot devices 12, 14 and a separate locking plate or padlock hasp 15. FIG. 1 illustrates the front face of pivot device 12 and the rear face of pivot device 14. Each pivot device 12, 14 comprises an elongated plate or pivot arm with an opening 16 at one end and a small lock opening 17 on one side. The opposite end is rotatably secured to pivot pin 18 extending from pivot mounting plate 20 through an opening in the respective arm and having a head 19 at its outer end. The mounting plates 20 of the respective arms are secured in the same position on opposite sides of a trash container, and a pipe or bar 21 is secured between the free ends of the arms so as to be pivotable from a position extending across the front of the container to a locking position rotated upwards and rearwards to extend over the top of the closed lid 23, as seen in FIG. 2. The separate locking plate 15 has a slot 22 and is secured to one side of the container (the left hand side in this case) at a position in which the lock opening 17 in the pivot arm 12 on that side is aligned with the slot 22 in the locking plate or hasp when the pipe 21 is in the locking position, as seen in FIG. 2. A shackle of a padlock (not illustrated) is then secured through the aligned opening and slot and locked to secure the bar in the locked position, so that the container lid cannot be opened. One problem with this arrangement is that it can be difficult to position the locking plate 15 on installation so that opening 17 is aligned with slot 22 in the locking position.

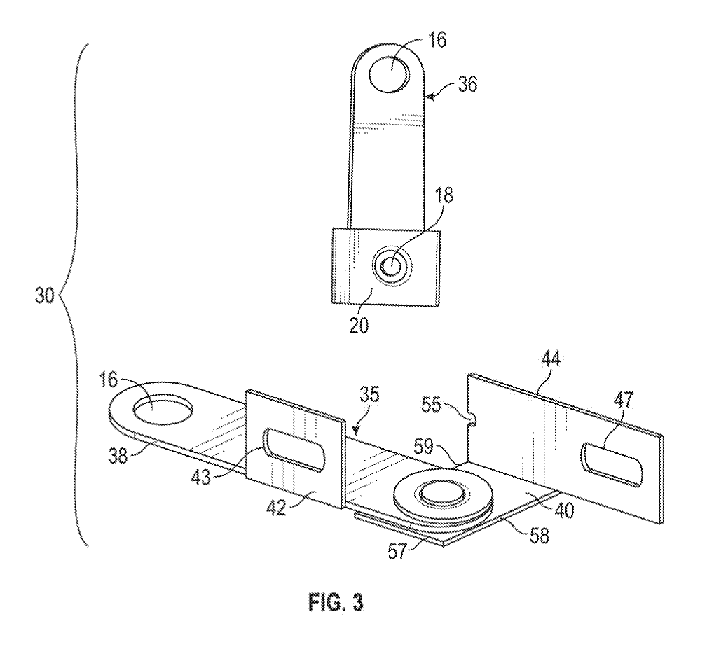

FIGS. 3 to 10 illustrate an embodiment of a lid lock apparatus 30 for locking a hinged lid 32 of a trash container 34 in a closed position (see FIG. 10). The apparatus 30 basically comprises a first, locking pivot device 35 and a second pivot device 36 which is not lockable. FIG. 3 illustrates the front of the first pivot device 35 and the rear of the second pivot device 36. In one embodiment, the second pivot device is similar or identical to the pivot devices 12, 14 of the prior art apparatus illustrated in FIG. 1, and like reference numbers have been used for like parts as appropriate. In the illustrated embodiment, the locking pivot device 35 is designed for installation on the left hand side of a trash container, but it could alternatively be designed for installation on the right hand side.

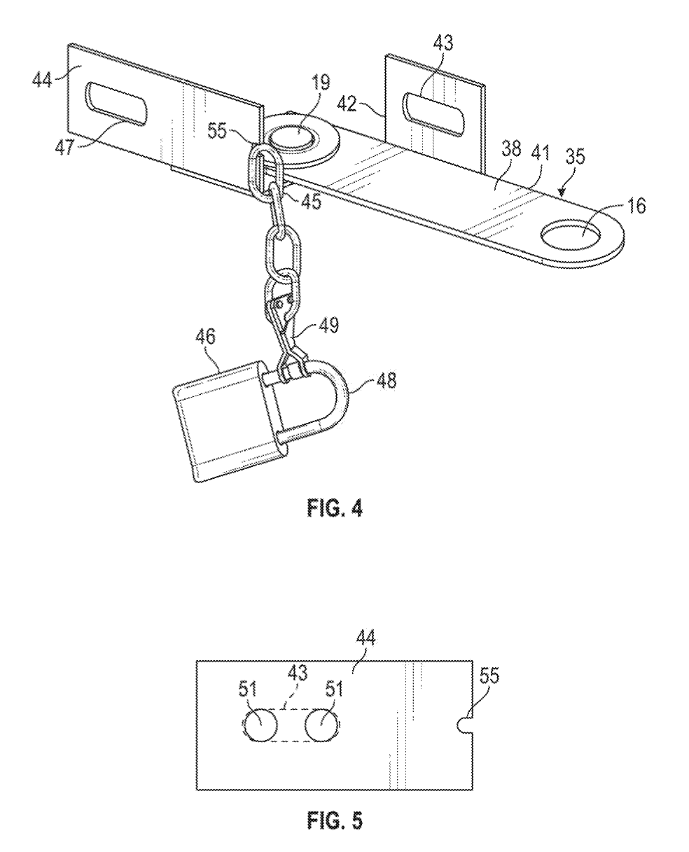

The first, locking pivot device 35 comprises an elongated plate or pivot arm 38, a pivot mount or mounting plate 40 pivotally connected to one end of pivot arm 38, a locking plate or flange 42 located on one side edge 41 of arm 38 and extending outward from a top surface of the arm 38, and a stop plate or lock hasp 44 extending outward from a top surface of pivot mount 40. Plate or pivot arm 38 is pivotally mounted at one end on a pivot pin 19 extending from pivot mount 40, in a similar manner to prior art device 12 described above. In some embodiments, locking flange 42 is oriented substantially perpendicular to pivot arm 38 and parallel to the longitudinal axis of arm 38, and stop plate or padlock hasp 44 is oriented perpendicular to mounting plate 40, as best seen in FIGS. 4, 6 and 8, but these parts may be angled differently in alternative embodiments as long as the locking flange 42 is pivoted into a position adjacent the stop plate or lock hasp 44 in the lid locking position of the pivot devices 35 and 36 (see FIG. 10). Locking flange 42 has an elongated slot 43 while stop plate 44 has an elongated slot 47. In alternative embodiments, one of the slots may be replaced by one or more circular holes 51, as seen in FIG. 5. The stop plate or lock hasp 44 is integrated with or secured to the pivot mounting plate rather than being a completely separate part as in the prior art arrangement described above, and is pre-aligned with the locking flange 42 on pivoted plate 38 rather than having to be aligned separately on installation by the installer. When the pivot mounting plate 40 is correctly mounted on the rim of the trash container as described in more detail below, lock hasp or stop plate 44 is automatically in the correct position and orientation for face-to-face engagement with locking flange 42 with the slots 43, 47 overlapping or aligned when the pivot plates and secured pipe or bar are rotated into the lid locking position. This makes installation of the pivot arms much easier.

Locking flange 42 and stop plate 44 may be formed integrally with the respective pivot arm or plate 38 and mounting plate 40 and may be bent or formed to extend perpendicular to the respective pivot plate 38 and mounting plate 40, or may be formed as separate parts and secured to plates 38, 40 by welding or the like. In some embodiments, pivot mount or plate 40 has spaced side edges 57 and first and second end edges 58, 59, respectively, and the stop plate 44 is located at one of the side edges 57. Stop plate 44 is longer than pivot mount or plate 40 and extends outwards from side edge 57 beyond the first end edge 58 of plate or mount 40. In some embodiments, stop plate 44 has a length between opposite end edges which is around twice the distance between the first and second end edges 58, 59 of the mounting plate or pivot mount 40. Slot 47 is located in the part of stop plate 44 which protrudes from first end edge 58 of the pivot mount or plate 40.

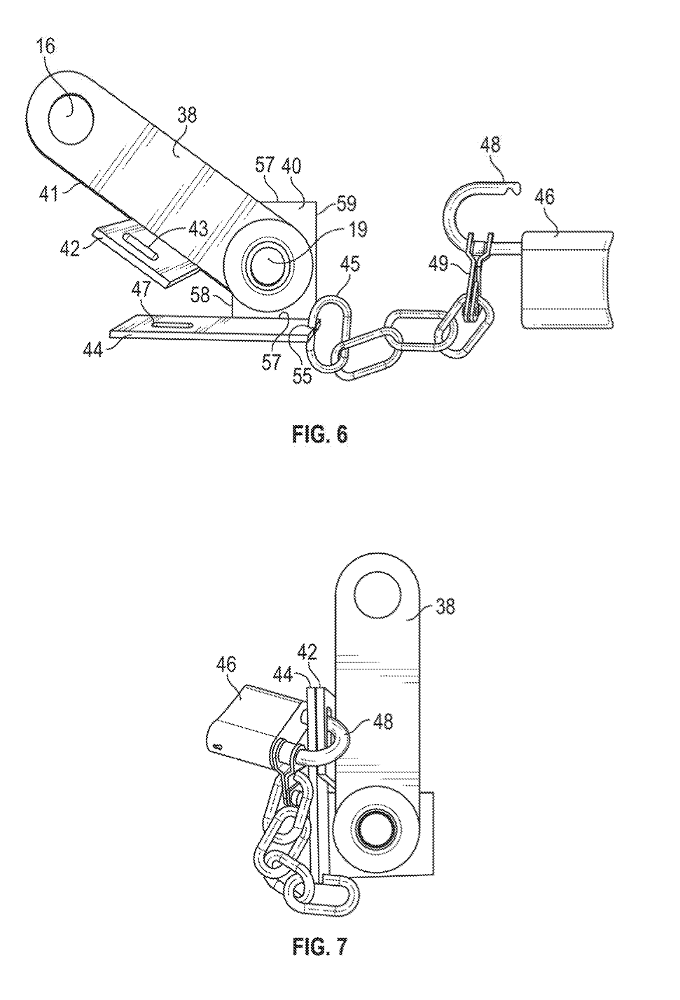

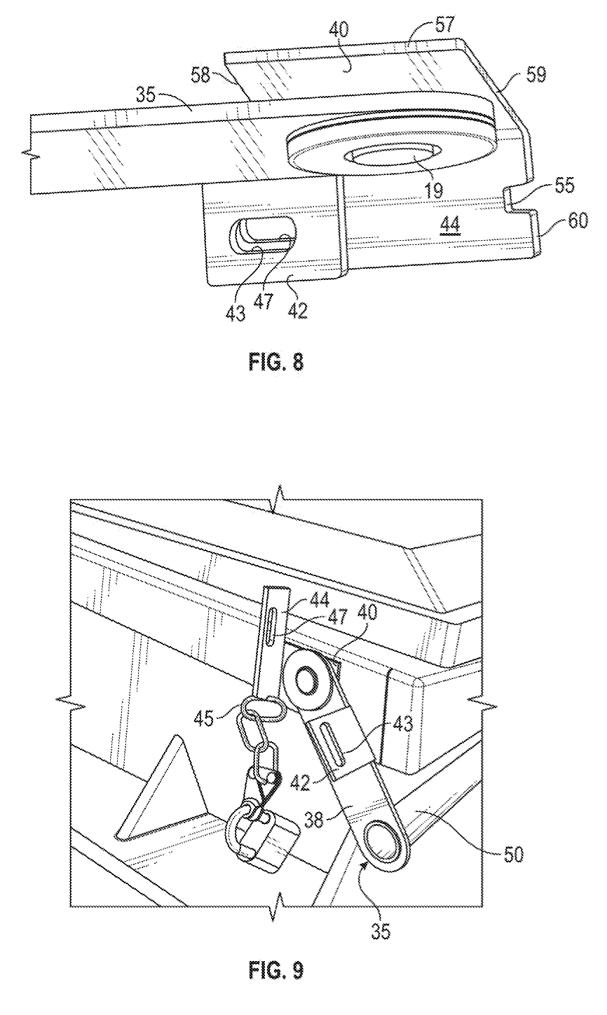

As seen in FIGS. 4 and 8, one end edge 60 of stop plate 44 has a central notch or indent 55 which is provided as a weld point for attachment of a padlock to the locking pivot device 35. In one embodiment, a short length of chain 45 is secured or welded in notch 55 of plate 44, as seen in FIGS. 4, 6 and 7. The opposite end of chain 45 is attached to a shackle 48 of a selected padlock 46 via a suitable connector 49, as seen in FIGS. 4 and 6. A padlock secured to the lockable pivot arm is much less likely to get lost and can be preset to a selected combination provided only to authorized users of the trash container. Trash collection truck drivers have an override key for opening the trash container when trash is collected. Another advantage of securing the padlock to the pivot mounting plate is that it is easier to lock the plate or pivot arm 38 to stop plate 40 when the padlock is readily available or when in low visibility or dark conditions.

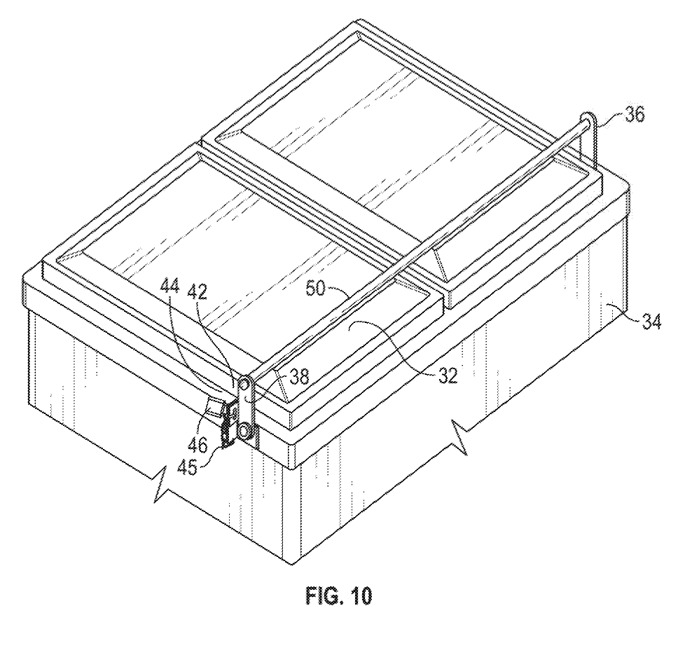

In order to install the lid locking apparatus on a trash container, the pivot mounts or mounting plates 40, 20 of the respective pivot devices 35, 36 are first secured by welding or other fastening means at identical positions on the upper rim 62 on opposite sides of trash container 34 in an orientation in which the upper and lower edges (or longer edges) 58, 59 are parallel to the side edge of the dumpster lid in the closed position. For ease of installation, the height of plate 40 between the upper and lower edges may be substantially the same as the height of rim 62. The pivot mounting plate 40 of the locking pivot arm is positioned with the stop plate or padlock hasp 44 furthest away from the front end of the dumpster. In the installed position, the projecting end of hasp 44 extends in a direction upwards from the mounting plate 40 towards the top opening of the container, as seen in FIGS. 9 and 10. A length of metal pipe or bar 50 is first measured against the front end of the dumpster or trash container so that it is of sufficient length to be secured between the ends of pivot arms 35 and 36, and the pipe or bar 50 is then secured between openings 16 at the outer ends of the pivot arms, as seen in FIGS. 9 and 10. In FIG. 9, the pipe or bar 50 extends across the front of the container so that the lid 32 may be freely opened to deposit trash inside the container, and the locking flange 42 is spaced away from stop plate or hasp 44 with pivot arm 38 extending downwards and angled away from the stop plate.

In order to lock the lid 32 of the trash container in the closed position, the bar 50 is rotated upwards and rearwards over the top of the container, simultaneously pivoting the pivot arms of pivot devices 35 and 36 about their pivot axis so that the locking flange 42 of locking pivot arm 38 is rotated towards stop plate 44. FIG. 6 illustrates an intermediate position in which the locking flange is approaching stop plate 44. FIGS. 7, 8 and 10 illustrate the locking flange in the locking position in face-to-face engagement with the stop plate or hasp 44. As illustrated in FIG. 8, the slots 43, 47 are substantially aligned in this position. The stop plate 44 also identifies the locking position by preventing further rotation of arm 38 when locking flange 42 contacts plate 44. At the same time, the bar 50 extends across the closed lid 32 of the container, as seen in FIG. 10. The shackle 48 of the attached padlock 46 is then extended through the aligned slots or openings 43, 47 in the locking flange and stop plate, and locked to hold the bar 50 in the position shown in FIG. 10. This prevents access to the container by unauthorized individuals. When an authorized individual having a key or combination for padlock 46 wishes to deposit trash in the container, they simply unlock and remove the padlock from the aligned openings and move the lock bar 50 forwards to the front of the container, simultaneously rotating plate 38 back from the position shown in FIG. 10 to the position shown in FIG. 9.

The lid lock apparatus in the above embodiments is much easier to install and operate than the prior art apparatus of FIGS. 1 and 2. Unlike that apparatus in which the lock plate or lock hasp 15 was separate from the pivot device 12, the lock hasp or stop plate 44 in this apparatus is integral with or secured to the pivot mount or base plate 40 at the correct position and orientation to engage locking flange 42 with the slots overlapping or aligned when the pivot arm is rotated into the lid locking position. The stop plate also prevents further rearward movement of the pivot arms when the lid locking position is reached, unlike the prior art device (see FIG. 2). Additionally, a notch or indent is provided on the lock hasp for locating and welding the end of a chain secured to a padlock, so that the means for locking the apparatus in a lid locking position is readily available at all times for engagement through the aligned parts of the slots after opening and re-closing of the trash container lid.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A trash container lid locking apparatus, comprising:
first and second pivot devices;
the first pivot device comprising a first mounting plate configured to be secured to a first side edge of a trash container close to the front of the container and having a front face configured to face outwards from the side edge when installed, and a first pivot arm having a first end pivotally mounted on the first mounting plate and a second end, the second end having an attachment portion for attachment to a first end of an elongated bar which is longer than the front of the trash container;
the second pivot device comprising a second mounting plate configured to be secured to a second side edge of the trash container and a second pivot arm having a first end pivotally mounted on the second mounting plate and a second end, the second end of the second pivot arm having an attachment portion for attachment to a second end of the elongated bar;
the first pivot arm having opposite side edges and a locking flange extending outwards from one side edge of the elongated arm, the locking flange having a first opening; and
a stop plate extending outwards from the first mounting plate, the stop plate having a second opening;
whereby the first and second pivot arms are rotatable between an unlocked position in which the bar extends across the front of the container and the hinged container lid can be freely opened and closed, and a locking position in which the bar and arms are pivoted upward and rearward so that the bar extends over the top of the container lid; and
wherein the locking flange is configured to be positioned adjacent the stop plate with the first and second openings at least partially aligned to receive the shackle of a padlock when the first pivot arm is in the locking position.

2. The apparatus of claim 1, wherein at least one of the openings is an elongated slot.

3. The apparatus of claim 2, wherein both of the openings are elongated slots.

4. The apparatus of claim 1, wherein the locking flange and stop plate are configured to be positioned in face-to-face engagement when the first pivot arm is in the locking position.

5. The apparatus of claim 1, wherein the locking flange extends perpendicular to the first pivot arm and the stop plate extends perpendicular to the first mounting plate.

6. The apparatus of claim 1, further comprising a padlock and a chain securing the padlock to the first pivot device.

7. The apparatus of claim 6, wherein the stop plate has an end edge having at least one notch and the chain is welded in the notch of the stop plate.

8. The apparatus of claim 1, wherein the first mounting plate has opposite side edges and first and second end edges, and the stop plate is located along one side edge of the mounting plate and extends from the first end edge beyond the second end edge of the first mounting plate.

9. The apparatus of claim 8, wherein the second opening is located in a part of the stop plate extending beyond the second end edge of the first mounting plate.

10. A method of locking a trash container lid in a closed position, comprising:
mounting first and second pivot mounting plates on opposite side rims of a trash container adjacent the front wall and upper end opening of the container;
securing a locking bar between second ends of first and second pivot arms, the first and second pivot arms having respective first ends pivotally mounted on the respective first and second pivot mounting plates;
positioning the pivot arms in a first, unlocked position in which the locking bar extends across the front wall of the container;
closing the lid of the container;
rotating the first and second pivot arms in a first, locking direction upwards and rearwards into a locking position in which the locking bar extends across the closed lid of the container and a locking flange on the first pivot arm engages a stop plate on the first mounting plate which projects outwards from the first mounting plate and respective side rim of the container, wherein engagement between the locking flange and stop plate prevents further movement of the pivot arms in the first, locking direction; and
engaging the shackle of a padlock through aligned openings in the stop plate and locking flange and locking the shackle to the padlock body to retain the first and second pivot arms and locking bar in the locked position.
